(19) United States
(12) Patent Application Publication
(10) Pub. No.: US 2017/0088769 A1
(43) Pub. Date: Mar. 30, 2017

(54) AQUEOUS GUAR COMPOSITIONS FOR USE IN OIL FIELD AND SLICKWATER APPLICATIONS

(71) Applicant: RHODIA OPERATIONS, Paris (FR)

(72) Inventors: Subramanian KESAVAN, East Windsor, NJ (US); Ruela PABALAN, Burlington, NJ (US); Kailas SAWANT, Mars, PA (US); Kevin FREDERICK, Evans City, PA (US)

(73) Assignee: RHODIA OPERATIONS, Paris (FR)

(21) Appl. No.: 15/310,501

(22) PCT Filed: May 12, 2015
(86) PCT No.: PCT/US15/30271

§ 371 Date: Nov. 11, 2016

Related U.S. Application Data
(60) Provisional application No. 61/991,766, filed on May 12, 2014.

(51) Int. Cl. C09K 8/68; C09K 8/88; E21B 43/26; C09K 8/52; C09K 8/60; C09K 8/40; C09K 8/035; C09K 8/90

(52) U.S. Cl. CPC C09K 8/685; C09K 8/68; C09K 8/035; C09K 8/887; C09K 8/90; C09K 8/52; C09K 8/602; C09K 8/605; C09K 8/40; E21B 43/26; C09K 2208/28; C09K 2208/30

(57) ABSTRACT

Products, methods and processes for manufacture that are related to application fluid, more specifically, to oil field compositions that include a fracturing fluid composition prepared by a process including at least the steps of:—contacting a polysaccharide particle with water to produce process water, and—separating the process water from the polysaccharide particle, whereby the separated process water comprises at least part of the fracturing fluid composition.

### CROSS-REFERENCE TO RELATED APPLICATIONS

This application claims the benefit of U.S. Provisional Application No. 61/991,766, filed May 12, 2014, incorporated herein by reference in its entirety.

### FIELD OF THE INVENTION

This invention relates to products, methods and processes related to oil field compositions and, in particular, to use of process water derived from processing polysaccharide and polysaccharide derivatives, including guar, in slickwater fracturing compositions.

### BACKGROUND

Hydraulic fracturing is an important application in the oil and gas industry. However, due to recent push in government regulation, as well as the possible health and safety hazards to traditionally utilized chemicals used in fracturing, there is a need to seek alternative, friendly chemicals to use into hydraulic fracturing fluids.

Slickwater fracturing is a type of oil field fracturing application, which utilizes a low viscosity aqueous fluid to induce, enlarge, sustain and/or expand a fracture in a subterranean formation. Generally, slickwater fluids contain water having sufficient friction reducing agent to minimize the tubular friction pressures downhole, which viscosities are slightly higher than water or brine without the friction reducing agent. In slickwater applications, large volumes of water are required, which in some areas are not readily available or which need to be further processed and treated to be utilized in slickwater applications.

Typically, the friction reduction agents present in slickwater do not increase the viscosity of the fracturing fluid by more than 1 to 2 centipoise (cP). Typically, High molecular weight linear polymers such as polyacrylamides (PAMs) are used as the friction reducing agent. Often there is difficulty in handling such high molecular weight polymers because of their low rate of hydration and high viscosity when made into a slurry. To circumvent these problems, the polyacrylamide-based polymer is often made into an emulsion, where the polymer is dispersed in a hydrocarbon solvent, such as mineral oil, and stabilized with surfactants. However, this too has drawbacks because of the environmental toxicity of the hydrocarbons and the surfactants in case of a spill and the potential fire hazard associated with the hydrocarbon solvent.

Thus, there is a need to develop slickwater fracturing fluids that have effective friction reduction that are environmentally friendly or provide a sustainability benefit.

There is also a need to develop application fluids in the agriculture (e.g., seed boosting, germination, adjuvant) markets, home and personal care markets, industrial markets, paper and pulp process markets, mining markets, as well applications related to fire and dust suppression, to name a few, that are environmentally friendly or provide a sustainability benefit.

### SUMMARY

Described herein are solutions related to oil field compositions and applications, in particular to slickwater applications. Guar derivatives, such as hydroxypropyl guar(HPG), carboxymethyl guar(CMG), carboxymethyl hydroxypropyl guar(CMHPG) and cationic guars are manufactured from guar splits or guar powder as a starting point and then washed with water to remove the impurities, byproducts and residual unreacted reagents. This generates substantial amounts of process water that must be treated or processed. For example, typical processing of guar derivatives generate about 5-100 lb of process water for every lb of product that is made. The wash water (hereinafter also referred to as “guar processing side stream” or “process water”) contains guar derivatives and/or fines, as well as other components that, that can be used in oil field applications such as slickwater applications. It is also understood that other polysaccharides can be manufactured in a similar manner, wherein the process water contains polysaccharide, polysaccharide derivatives and/or fines, as well as other components that, that can be used in oil field applications such as slickwater applications.

In one aspect, described herein are oil field compositions comprising:
(optionally) a biocide; and
an aqueous friction reducer composition.

The aqueous friction reducer composition is, in one embodiment, prepared by the process comprising the steps of:
treating a polysaccharide particle with an effective amount of a crosslinker to produce a crosslinked polysaccharide particle;
contacting the crosslinked polysaccharide particle with water; and
separating the water from the polysaccharide particle to obtain the aqueous friction reducer composition.

In one embodiment, the aqueous friction reducer composition is a side stream from guar processing, i.e., a guar processing side stream.

In another aspect, described herein are oil field compositions comprising a fracturing fluid composition prepared by a process comprising at least the steps of:
contacting a polysaccharide particle with water to produce process water, and
separating the process water from the polysaccharide particle, whereby the separated process water comprises at least part of the fracturing fluid composition.

In one embodiment, the oil field compositions described herein further comprise one or more biocides, one or more surfactants, one or more scale inhibitors, one or more stabilizers or any of the foregoing.

In another embodiment, the process further comprises the step of treating the polysaccharide particle with an effective amount of a crosslinker to produce a polysaccharide particle. In another embodiment, the process further comprises the step of concentrating the process water.

The fracturing fluid composition, in one embodiment, is an aqueous friction reducer fluid composition. In a further embodiment, the oil field composition is a slickwater composition.

In yet another embodiment, the step of contacting the polysaccharide particle with water to produce process water comprises: washing the polysaccharide particle in water. The polysaccharide particle, in one embodiment, is a derivatized polysaccharide particle. In one embodiment, the polysaccharide particle is characterized by a substituent degree of substitution with a lower limit of 0.001 and an upper limit of 3.0, and a weight average molecular weight with a lower limit of 50,000 and an upper limit of 5,000,000.

In one embodiment, the polysaccharide particle is selected from the group comprising: guar, carboxymethyl guar (CMG), hydroxyethyl guar (HEG), hydroxypropyl guar (HPG), carboxymethylhydroxypropyl guar (CMHPG), cationic guar, cationic carboxymethyl guar (CMG), cationic hydroxyethyl guar (HEG), cationic hydroxypropyl guar (HPG), or any combination thereof. In another embodiment, the polysaccharide particle is selected from the group comprising: guar, carboxymethyl guar (CMG), hydroxyethyl guar (HEG), hydroxypropyl guar (HPG), carboxymethylhydroxypropyl guar (CMHPG), cationic guar, cationic carboxymethyl guar (CMG), cationic hydroxyethyl guar (HEG), cationic hydroxypropyl guar (HPG), hydrophobically modified guar (HM guar), hydrophobically modified carboxymethyl guar (HMCM guar), hydrophobically modified hydroxyethyl guar (HMHE guar), hydrophobically modified hydroxypropyl guar (HMHP guar), cationic hydrophobically modified hydroxypropyl guar (cationic HMHP guar), hydrophobically modified carboxymethylhydroxypropyl guar (HMCMHP guar), hydrophobically modified cationic guar (HM cationic guar) or any combination thereof.

The oil field composition as described herein can further comprise one or more surfactants, one or more scale inhibitors, one or more preservatives, one or more activators, one or more stabilizers or any of the foregoing. The polysaccharide particle can be, in some embodiments, partially swollen or incompletely hydrated.

The process water, in a further embodiment, is characterized by a pH in the range of between pH 8 and 12, or a pH of between 3 and 13. In one embodiment, the pH is characterized by an upper limit of pH 12. In one embodiment, the pH is characterized by an upper limit of pH 11. In one embodiment, the pH is characterized by an upper limit of pH 10. In one embodiment, the pH is characterized by an upper limit of pH 9. In one embodiment, the pH is characterized by a lower limit of pH 6. In one embodiment, the pH is characterized by a lower limit of pH 7. In one embodiment, the pH is characterized by a lower limit of pH 8. The composition as described herein can further comprise one or more surfactants, one or more scale inhibitors, one or more stabilizers (such as, e.g., clay, etc.) or any of the foregoing. In some embodiment, the process as described further comprises the step of neutralizing the process water. The process water is sometimes characterized by a pH greater than about 12, which in such a case it is desireable to lower the pH to that less than about 12 for transport and handling purposes.

In another aspect, described herein are methods of treating a subterranean formation, comprising:—providing the oil field composition as described herein; and—introducing the oil field composition into a wellbore penetrating the subterranean formation. In some embodiments, the polysaccharide particle is a crosslinked polysaccharide particle.

The oil field composition, in one embodiment, is a slickwater composition.

In a further embodiment, the step of contacting the polysaccharide particle with water comprises: washing the polysaccharide particle in water. The polysaccharide particle, in another embodiment, can have a substituent degree of substitution with a lower limit of 0.001 and an upper limit of 3.0, and a weight average molecular weight with a lower limit of 50,000 and an upper limit of 5,000,000.

In one embodiment, the polysaccharide particle is selected from the group comprising: native guar, carboxymethyl guar (CMG), hydroxyethyl guar (HEG), hydroxypropyl guar (HPG), carboxymethylhydroxypropyl guar (CMHPG), cationic guar, cationic carboxymethyl guar (CMG), cationic hydroxyethyl guar (HEG), cationic hydroxypropyl guar (HPG), or any combination thereof.

In one embodiment, the step of introducing the oil field composition into the wellbore penetrating the subterranean formation comprises introducing the oil field composition at a pressure sufficient to create, expand or sustain a fracture in the subterranean formation.

The oil field composition can also further comprise one or more surfactants, one or more scale inhibitors, one or more stabilizers or any of the foregoing.

In another aspect, described herein are methods of treating a subterranean formation, comprising:
introducing an oil field composition into a wellbore penetrating the subterranean formation,
whereby the oil field composition comprises process water obtained in the process of manufacturing polysaccharide or derivatized polysaccharide.

In some embodiments, the polysaccharide is guar. In other embodiments, the step of introducing the oil field composition into the wellbore penetrating the subterranean formation comprises introducing the oil field composition at a pressure sufficient to create, expand or sustain a fracture in the subterranean formation.

In a further aspect, described herein are methods of treating a subterranean formation comprising:
obtaining an oil field composition prepared from a process comprising at least the steps of:
   a) contacting a polysaccharide particle with water to produce process water, and
   b) separating the process water from the polysaccharide particle, whereby the separated process water comprises at least part of the oil field composition; and
introducing the oil field composition into a wellbore penetrating the subterranean formation

In some embodiments, the process is a process of manufacturing polysaccharide or derivatized polysaccharide.

In yet another aspect, described herein are methods of producing an application fluid composition, comprising at least the steps of:
contacting a polysaccharide particle with water to produce process water, and
separating the process water from the polysaccharide particle, whereby the separated process water comprises at least part of the application fluid composition. The application fluid composition, in some embodiments, is an agricultural composition, mining composition, suppression (dust, fire, etc.) composition, personal care composition, or home care composition.

The methods can further comprise-contacting the application fluid composition with one or more surfactants, one or more scale inhibitors, one or more stabilizers, one or more biocides, or any of the foregoing.

### BRIEF DESCRIPTION OF DRAWINGS

FIG. 1 is a chart of Friction Reduction versus time of the guar Process Water.

FIG. 2 is a chart illustrating the effect of dilution of the guar Process Water with additional (fresh) water.

FIG. 3 is a chart illustrating the effect of PHPA Emulsion on fresh water as a Comparative Example.

FIG. 4 is a chart illustrating the effect of PHPA Emulsion on 50/50 Mix of Guar Process Water/fresh water, respectively.

FIG. 5 is a chart illustrating the effect of PHPA Emulsion on 10/90 Mix of Guar Process Water/fresh water, respectively.

FIG. 6 is a chart illustrating the effect of PHPA Emulsion on 50/50 Mix of Guar Process Water/fresh water, respectively, with the addition of Total Dissolved Solids (TDS).

### DETAILED DESCRIPTION

As used herein, the term “alkyl” means a saturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the terminology “(Cr-Cs)” in reference to an organic group, wherein r and s are each integers, indicates that the group may contain from r carbon atoms to s carbon atoms per group.

As used herein, the terminology “surfactant” means a compound that when dissolved in an aqueous medium lowers the surface tension of the aqueous medium.

As used herein, it is understood that “oilfield application fluid” means any fluid utilized in the processing, extraction or treatment of oil, which in one embodiment includes fluids utilized in and around an oil producing well. Some oil application fluids include but are not limited to: well treatment fluids, stimulation fluids, slickwater fluids, drilling fluids, acidizing fluids, workover fluids, completion fluids, packer fluids, subterranean formation treating fluids, mud-reversal fluids, deposit removal fluids (e.g., asphaltene, wax, oil), wellbore cleaning fluids, cutting fluids, carrier fluids, carrier fluids (for mutual solvency), degreasing fluids, fracturing fluids, spacer fluids, hole abandonment fluids, among others.

Workover fluids generally are those fluids used during remedial work in a drilled well. Such remedial work includes removing tubing, replacing a pump, cleaning out sand or other deposits, logging, etc. Workover also broadly includes steps used in preparing an existing well for secondary or tertiary recovery such as polymer addition, micellar flooding, steam injection, etc. Fracturing fluids are used in oil recovery operations where subterranean is treated to create pathways for the formation fluids to be recovered.

Slickwater fracturing is a type of oil field fracturing application, which utilizes a low viscosity aqueous fluid to induce, enlarge and/or expand a fracture in a subterranean formation. Generally, slickwater fluids contain water having sufficient friction reducing agent to minimize the tubular friction pressures downhole, which viscosities are slightly higher than water or brine without the friction reducing agent.

At present, process water or guar processing side stream is generally not utilized in any reuse/recycling application, but treated in a classical water treatment process to meet the discharge requirements and then discharged or shipped to a waste treatment facility where it gets mingled with other industrial waste/residential waste and gets treated.

It has been found that the process water can be used as a component for hydraulic fracturing composition in fracturing /drilling applications. While not being bound by theory, it is believed that the process water contains sufficient amount of guar or guar derivatives dissolved therein, such that the process water (optionally further processed) can be used as a component for hydraulic fracturing composition in fracturing /drilling applications. In applications such as slick water fracturing, oil and gas operators purchase fresh water and add friction reduction polymers to obtain the desired friction reduction. It has been found that the process water, by itself provides the desired friction reduction characteristics without the need for additional friction reduction polymers. The process water can also be added with other water sources at different ratios and, if necessary, supplemented with a small amount of friction reducer to get the desired friction reduction characteristics. Because of this discovery, the discharge of the process water can be eliminated and the overall water cycle can be made more sustainable.

Implementing the guar process water for use in oil and gas applications such as slickwater fracturing has several key benefits such as, the discharge of and/or treatment guar process water as can be reduced or eliminated. This can lead to an increase of capacity of the guar processing plant, can act as a substitute for fresh water used in fracking as well as replace friction reduction polymers used in slick water applications.

Thus, oil field compositions can be prepared utilizing the guar processing side stream or process water. Such oil field compositions comprise a fracturing fluid and, in some embodiments, optionally, a biocide. The fracturing fluid composition is typically prepared by a process comprising at least the steps of:—contacting a polysaccharide particle with water to produce process water, and—separating the process water from the polysaccharide particle, whereby the separated process water comprises at least part of the fracturing fluid composition. The process water used in the present invention can be derived from a continuous process stream or effluent or a batch process, and can be made up of from one wash step to two or more wash steps.

Described herein are also methods of treating a subterranean formation, comprising:—providing the oil field composition as described herein; and—introducing the oil field composition into a wellbore penetrating the subterranean formation.

In one embodiment, the method of treating a subterranean formation, comprises
introducing an oil field composition into a wellbore penetrating the subterranean formation,
   whereby the oil field composition comprises process water obtained in the process of manufacturing polysaccharide or derivatized polysaccharide. Introducing the oil field composition into the wellbore is typically performed at a pressure sufficient to create, expand or sustain a fracture in the subterranean formation.

In another embodiment, the method of treating a subterranean formation comprises:
obtaining an oil field composition prepared from a process comprising at least the steps of:
   a) contacting a polysaccharide particle with water to produce process water, and
   b) separating the process water from the polysaccharide particle, whereby the separated process water comprises at least part of the oil field composition; and
introducing the oil field composition into a wellbore penetrating the subterranean formation

Further described herein are methods of producing an oil field composition comprising the steps of:
obtaining an aqueous friction reducer composition prepared at least in part by:
treating a polysaccharide particle with an effective amount of a crosslinker to produce a crosslinked polysaccharide particle;
contacting the crosslinked polysaccharide particle with water
separating the water from the polysaccharide particle, the water forming all or part of the aqueous friction reducer composition; and
contacting the aqueous friction reducer with one or more surfactants, one or more scale inhibitors, one or more stabilizers, one or more biocides, or any of the foregoing.

The guar process water is, in one embodiment, the water (including fines are small particulates) removed from the washed polysaccharide particles. The preparation of the polysaccharide derivatives and guar process water or processing side stream will be discussed in detail below.

Typically, the preparation of polysaccharide and polysaccharide derivatives, which in one embodiment is a guar, includes reacting the polysaccharide or guar in a semi-dry, dry or powder form with a cationizing reagent in water (or a mixture of water and water miscible solvent e.g., alcohol medium), where the water or mixture contains a catalyst such as a base or an initiator. In one embodiment, the guar is CMHPG or HPG.

In another embodiment, the polysaccharide or guar in a semi-dry, dry or powder form is reacted (with or without a cationizing reagent or a derivatizing agent) in a water miscible or immiscible solvent e.g., alcohol medium. This is followed by treatment or purification with or without an alkaline base or initiator. The alcohol medium is, in one embodiment, aqueous alcohol slurry which provides sufficient water to provide at least slight swelling of the guar while at the same time maintain the integrity of the suspended guar particles. An amount of water of up to 10%, 20%, 30%, 50% or 60% by weight based on the total weight of the aqueous solvent system may be used in carrying out this process.

In one embodiment, the polysaccharide powder, typically guar, is characterized by a mean particle diameter of 10 microns (μm) to 500 microns. In another embodiment, the polysaccharide powder is characterized by a mean particle diameter of 10 microns to 100 microns. In yet another embodiment, the polysaccharide powder is characterized by a mean particle diameter of 10 microns to 50 microns. In one embodiment, the polysaccharide powder is characterized by a mean particle diameter having a lower limit of 30 microns, in another embodiment, having a lower limit of 20 microns, and in another embodiment a preferred lower limit of 10 microns. In one embodiment, the polysaccharide powder is characterized by a mean particle diameter having an upper limit of 500 microns, in another embodiment, having an upper limit of 250 microns, and in another embodiment a preferred upper limit of 100 microns.

In one embodiment, the polysaccharide splits, typically guar splits, are characterized by a mean particle diameter having an upper limit of 10 mm. In another embodiment, the polysaccharide splits, typically guar splits, are characterized a mean particle diameter having an upper limit of 8 microns (μm). In another embodiment, the polysaccharide splits are characterized a mean particle diameter having an upper limit of 5 microns (μm). In another embodiment, the polysaccharide splits are characterized a mean particle diameter having an upper limit of 2 microns (μm). In another embodiment, the polysaccharide splits are characterized a mean particle diameter having an upper limit of 1 micron (μm). In another embodiment, the polysaccharide splits are characterized a mean particle diameter having an upper limit of 0.7 microns (μm). In another embodiment, the polysaccharide splits are characterized a mean particle diameter having an upper limit of 0.5 microns (μm). In another embodiment, the polysaccharide splits are characterized a mean particle diameter having an upper limit of 0.2 microns (μm).

In one embodiment, the polysaccharide splits, typically guar splits, are characterized by a mean particle diameter having an upper limit of 10 mm. In another embodiment, the polysaccharide splits, typically guar splits, are characterized a mean particle diameter having an upper limit of 8 microns (μm). In another embodiment, the polysaccharide splits are characterized a mean particle diameter having an upper limit of 7 microns (μm). In another embodiment, the polysaccharide splits are characterized a mean particle diameter having an upper limit of 5 microns (μm). In another embodiment, the polysaccharide splits are characterized a mean particle diameter having an upper limit of 2 microns (μm). In another embodiment, the polysaccharide splits are characterized a mean particle diameter having an upper limit of 1 micron (μm).

In a further embodiment, the polysaccharide splits, typically guar splits, are characterized a mean particle diameter having a lower limit of 0.1 microns (μm). In yet another embodiment, the polysaccharide splits, typically guar splits, are characterized a mean particle diameter having a lower limit of 0.2 microns (μm). In one embodiment, the polysaccharide splits are characterized a mean particle diameter having a lower limit of 0.3 microns (μm). In another embodiment, the polysaccharide splits are characterized a mean particle diameter having a lower limit of 0.5 microns (μm). In one embodiment, the polysaccharide splits are characterized a mean particle diameter having a lower limit of 0.7 microns (μm). In one embodiment, the polysaccharide splits are characterized a mean particle diameter having a lower limit of 0.9 microns (μm).

The alcohol medium or solvents that are used are, in one embodiment, alcohols including but not limited to monohydric alcohols of 2 to 4 carbon atoms such as ethanol, isopropyl alcohol, n-propanol and tertiary butanol. In one embodiment the alcohol is isopropyl alcohol. The alkaline base that is used in this process is alkali metal hydroxide or ammonium hydroxide, typically, sodium hydroxide. The amount of alkaline base used can vary from about 10 to about 100% and, typically, from about 20 to 50% by weight, based on the weight of polysaccharide, guar or guar derivative utilized.

In some embodiments, a crosslinking agent is used to partially and temporarily crosslink the guar chains during processing, thereby reducing the amount of water absorbed by the guar during the one or more washing steps. Borax (sodium tetra borate) is used in one embodiment, where the crosslinking process takes place under alkaline conditions and is reversible allowing the product to hydrate under acidic conditions. Maintaining the moisture content of the derivatized splits at a relatively low level, typically a moisture content of less than or equal to about 90 percent by weight, simplifies handling and milling of the washed derivatized splits. In the absence of crosslinking, the moisture content of washed derivatized splits is relatively high and handling and further processing of the high moisture content splits is difficult. Prior to end-use application, for example, as a thickener in an aqueous personal care composition such as a shampoo, the crosslinked guar is typically dispersed in water and the boron crosslinking then reversed by adjusting the pH of the guar dispersion, to allow dissolution of the guar to form a viscous aqueous solution.

In some embodiments, the crosslinking agents include but are not limited to copper compounds, magnesium compounds, glyoxal, titanium compounds, calcium compounds, aluminum compounds, p-benzoquinone, dicarboxylic acids and their salts, compounds and phosphate compounds.

After the reaction, the obtained product is separated by sedimentation, such as but not limited to centrifugation, or filtration (for both split and powder processes). Prior to such separation, however, intermediate steps can be taken to purify the product, such as washing. One or more washing steps can be utilized. In one embodiment, purifying the product in a washing process comprises a first washing step with water or water/solvent mixture and/or a second washing step with a diluted or undiluted water-solvent mixture (e.g., solvent process).

In another embodiment, the intermediate steps include one or more aqueous solution washes, including but not limited to a first water wash, and a second water wash. Optionally, a third water wash can be utilized. The water may be purified water, deionized water, tap water or non-processed water (e.g., split process). The one or more washing steps can also be part of an iterative process, which for example can be repeating at least once the combined steps of washing then centrifugation/filtration.

The one or more wash steps are conducted in any suitable process vessel. Each wash step may be conducted as a batch process, such as for example, in a stirred mixing vessel, or as a continuous process, such as for example, in a wash column wherein a stream of the derivatized guar splits is contacted with a co-current or counter-current stream of aqueous wash medium.

In one embodiment, the product can be washed with an aqueous medium by contacting the guar or derivatized guar with the aqueous medium and then physically separating the aqueous wash medium, which is in the form of process water or effluent (or guar processing side stream), from the guar or derivatized guar particles. In some embodiments, the process water can contain residual reactants, traces of the final product, and/or impurities such as by products and un-reacted reagents. For example, after the reaction process the swollen splits are dewatered in a filtration system, which is shaken to remove the wash effluent from the solids (solid-liquid separation). The filtration system, in one embodiment, utilizes mesh screening to remove all the process water along with particles smaller than the screen mesh opening. Removal of the liquids from solid guar particles can be through, for example, centrifugal force, gravity or pressure gradient. Examples include sieve filtering, high flow rate centrifugal screening, centrifugal sifters, decanting centrifuges, and the like. In one embodiment, the mesh screen from about 100 mesh (150 microns) to about 500 mesh (25 microns). In other embodiments, the mesh screen can be up to 700 mesh or greater.

In some embodiments, the guar (including natural or derivatized guar) is then washed in a washing column (e.g., a hydraulic wash column) where additional water or an aqueous solution is introduced along with the guar. This is performed to further clean or purify the processed guar. In some embodiments, the guar-water mixture after washing in the wash column is again dewatered in a filtration system. In some embodiments, the step of washing the processed guar in the wash column followed by the step of dewatering in a filtration system is considered to be one “wash step”.

In one exemplary embodiment, process water or guar processing side stream is obtained from filtering immediately after the reaction process, and more process water is obtained after one or more washing steps and, finally, final process water is obtained after final centrifugation prior to a drying/milling process. Typically, after a first wash, the process water can contain mostly impurities such as salts and by-products; after a second wash (and subsequent washes), the process water contains less impurities and more dissolved or solubilized guar.

Such process water or guar processing side stream is utilized as a component in an oil field composition, specifically a slick water application. The process water can form part or all of a friction reducer composition.

In one embodiment, the polysaccharide is a locust bean gum. Locust bean gum or carob bean gum is the refined endosperm of the seed of the carob tree, Ceratonia siliqua. The ratio of galactose to mannose for this type of gum is about 1:4. In one embodiment, the polysaccharide is a tara gum. Tara gum is derived from the refined seed gum of the tara tree. The ratio of galactose to mannose is about 1:3.

In one embodiment, the polysaccharide is a polyfructose. Levan is a polyfructose comprising 5-membered rings linked through β-2,6 bonds, with branching through β-2,1 bonds. Levan exhibits a glass transition temperature of 138° C. and is available in particulate form. At a molecular weight of 1-2 million, the diameter of the densely-packed spherulitic particles is about 85 nm.

In one embodiment, the polysaccharide is a xanthan. Xanthans of interest are xanthan gum and xanthan gel. Xanthan gum is a polysaccharide gum produced by Xathomonas campestris and contains D-glucose, D-mannose, D-glucuronic acid as the main hexose units, also contains pyruvate acid, and is partially acetylated.

In one embodiment, the polysaccharide of the present invention is derivatized or non-derivatized guar. Guar comes from guar gum, the mucilage found in the seed of the leguminous plant Cyamopsis tetragonolobus. The water soluble fraction (85%) is called “guaran,” which consists of linear chains of (1,4)-.β-D mannopyranosyl units-with α-D-galactopyranosyl units attached by (1,6) linkages. The ratio of D-galactose to D-mannose in guaran is about 1:2.

The guar seeds used to make guar gum are composed of a pair of tough, non-brittle endosperm sections, hereafter referred to as “guar splits,” between which is sandwiched the brittle embryo (germ). After dehulling, the seeds are split, the germ (43-47% of the seed) is removed by screening. The splits typically contain about 78-82% galactomannan polysaccharide and minor amounts of some proteinaceous material, inorganic salts, water-insoluble gum, and cell membranes, as well as some residual seedcoat and seed embryo.

In one embodiment, the polysaccharide is selected from guar or derivatized guar.

In one embodiment, the polysaccharide is selected from the group comprising: guar, carboxymethyl guar (CMG), hydroxyethyl guar (HEG), hydroxypropyl guar (HPG), carboxymethylhydroxypropyl guar (CMHPG), cationic guar, cationic carboxymethyl guar (CMG), cationic hydroxyethyl guar (HEG), cationic hydroxypropyl guar (HPG), cationic carboxymethylhydroxypropyl guar (CMHPG), hydrophobically modified guar (HM guar), hydrophobically modified carboxymethyl guar (HMCM guar), hydrophobically modified hydroxyethyl guar (HMHE guar), hydrophobically modified hydroxypropyl guar (HMHP guar), cationic hydrophobically modified hydroxypropyl guar (cationic HMHP guar), hydrophobically modified carboxymethylhydroxypropyl guar (HMCMHP guar), hydrophobically modified cationic guar (HM cationic guar) or any combination thereof.

The polysaccharide, in a preferred embodiment, is selected from the group comprising: guar (i.e., native guar), carboxymethyl guar (CMG), hydroxyethyl guar (HEG), hydroxypropyl guar (HPG), carboxymethylhydroxypropyl guar (CMHPG), cationic guar, cationic carboxymethyl guar (CMG), cationic hydroxyethyl guar (HEG), cationic hydroxypropyl guar (HPG), or any combination thereof. In yet another more preferred embodiment, the polysaccharide is selected from hydroxypropyl guar (HPG), carboxymethylhydroxypropyl guar (CMHPG), cationic hydroxypropyl guar (HPG), cationic carboxymethylhydroxypropyl guar (CMHPG) or any combination thereof.

The compositions described herein can also contain cationic, anionic, amphoteric or zwitterionic surfactants, as described in greater detail below.

The viscoelastic surfactants include zwitterionic surfactants and/or amphoteric surfactants and cationic surfactants. A zwitterionic surfactant has a permanently positively charged moiety in the molecule regardless of pH and a negatively charged moiety at alkaline pH. A cationic surfactant has a positively charged moiety regardless of pH. An amphoteric surfactant has both a positively charged moiety and a negatively charged moiety over a certain pH range (e.g., typically slightly acidic), only a negatively charged moiety over a certain pH range (e.g., typically slightly alkaline) and only a positively charged moiety at a different pH range (e.g., typically moderately acidic).

In one embodiment, the cationic surfactant is selected from i) certain quaternary salts and ii) certain amines, iii) amine oxide, iv) and combinations thereof.

The quaternary salts have the structural formula:

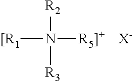

wherein R₁ is a hydrophobic moiety of alkyl, alkylarylalkyl, alkoxyalkyl, alkylaminoalkyl or alkylamidoalkyl. R₁ has from about 18 to about 30 carbon atoms and may be branched or straight-chained and saturated or unsaturated. Representative long chain alkyl groups include octadecentyl (oleyl), octadecyl (stearyl), docosenoic (erucyl) and the derivatives of tallow, coco, soya and rapeseed oils. The preferred alkyl and alkenyl groups are alkyl and alkenyl groups having from about 18 to about 22 carbon atoms.

R₂, R₃, and R₅ are, independently, an aliphatic group having from 1 to about 30 carbon atoms or an aromatic group having from 7 to about 15 carbon atoms. The aliphatic group typically has from 1 to about 20 carbon atoms, more typically from 1 to about 10 carbon atoms, and most typically from 1 to about 6 carbon atoms. Representative aliphatic groups include alkyl, alkenyl, hydroxyalkyl, carboxyalkyl, and hydroxyalkyl-polyoxyalkylene. The aliphatic group can be branched or straight-chained and saturated or unsaturated. Preferred alkyl chains are methyl and ethyl. Preferred hydroxyalkyls are hydroxyethyl and hydroxypropyl. Preferred carboxyalkyls are acetate and propionate. Preferred hydroxyalkyl-polyoxyalkylenes are hydroxyethyl-polyoxyethylene and hydroxypropyl-polyoxypropylene. Examples of aromatic moieties include cyclic groups, aryl groups, and alkylaryl groups. A preferred alkylaryl is benzyl.

X is suitable anion, such as Cl⁻, Br⁻, and (CH₃)₂SO₄⁻.

Representative quaternary salts of the above structure include methylpolyoxyethylene(12-18)octadecanammonium chloride, methylpolyoxyethylene(2-12)cocoalkylammonium chloride, and isotridecyloxypropyl polyoxyethylene (2-12) methyl ammonium chloride.

The amines have the following structural formula:

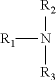

wherein R₁, R₂, and R₃ are as defined above.

Representative amines of the above structure include polyoxyethylene(2-15)cocoalkylamines, polyoxyethylene(12-18)tallowalkylamines, and polyoxyethylene(2-15)oleylamines.

Selected zwitterionic surfactants are represented by the following structural formula:

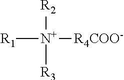

wherein R₁ is as described above. R₂ and R₃ are, independently, an aliphatic moiety having from 1 to about 30 carbon atoms or an aromatic moiety having from 7 to about 15 carbon atoms. The aliphatic moiety typically has from 1 to about 20 carbon atoms, more typically from 1 to about 10 carbon atoms, and most typically from 1 to about 6 carbon atoms. The aliphatic group can be branched or straight chained and saturated or unsaturated. Representative aliphatic groups include alkyl, alkenyl, hydroxyalkyl, carboxyalkyl, and hydroxyalkyl-polyoxyalkylene. Preferred alkyl chains are methyl and ethyl. Preferred hydroxyalkyls are hydroxyethyl and hydroxypropyl. Preferred carboxyalkyls are acetate and propionate. Preferred hydroxyalkyl-polyoxyalkylenes are hydroxyethyl-polyoxyethylene or hydroxypropyl-polyoxypropylene). R₄ is a hydrocarbyl radical (e.g. alkylene) with chain length 1 to 4 carbon atoms. Preferred are methylene or ethylene groups. Examples of aromatic moieties include cyclic groups, aryl groups, and alkylaryl groups. A preferred arylalkyl is benzyl.

Specific examples of selected zwitterionic surfactants include the following structures:

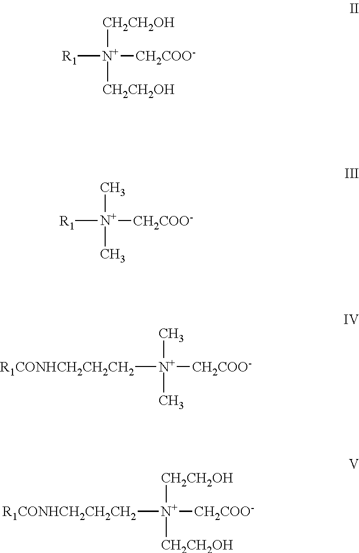

wherein R₁ is as described above.

Other representative zwitterionic surfactants include dihydroxyethyl tallow glycinate, oleamidopropyl betaine, and erucyl amidopropyl betaine.

Selected amphoteric surfactants useful in the viscoelastic surfactant fluid of the present invention are represented by the following structural formula:

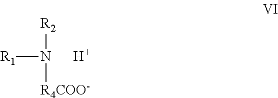

wherein R₁, R₂, and R₄ are as described above.

Specific examples of amphoteric surfactants include those of the following structural formulas:

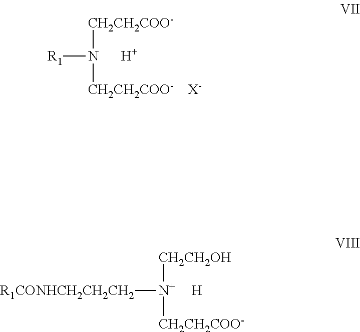

wherein R₁ is as described above. X⁺ is an inorganic cation such as Na⁺, K⁺, NH₄⁺ associated with a carboxylate group or hydrogen atom in an acidic medium.

The oil field compositions described herein, in alternative embodiments, can include (in either the product, process of making of), various other additives. Non-limiting examples include stabilizers, thickeners, corrosion inhibitors, mineral oils, enzymes, ion exchangers, chelating agents, dispersing agents, clay (e.g., Bentonite and attapulgite) and the like.

In one embodiment, the process water is comprised of the following dissolved or dispersed (as fines) in the water: (i) polysaccharide (natural or native guar), derivatized polysaccharide (e.g., derivatized guar), or a combination thereof, (ii) salt (e.g., NaCl). The (i) polysaccharide (natural or native guar), derivatized polysaccharide (e.g., derivatized guar), or a combination thereof, is present in an amount having an upper limited of (by weight of process water) 3 wt %, in one embodiment, having an upper limit of 2 wt %, in another embodiment, having an upper limit of 1 wt %, in another embodiment, having an upper limit of 0.8 wt %, in another embodiment, having an upper limit of 0.6 wt %, in another embodiment, having an upper limit of 0.5 wt %, in another embodiment, having an upper limit of 0.4 wt %, in another embodiment, having an upper limit of 0.3 wt %, in another embodiment, having an upper limit of 0.2 wt %, in another embodiment, having an upper limit of 0.1 wt %, in another embodiment.

The (ii) salt is present in an amount having an upper limited of (by weight of process water) 1 wt %, in one embodiment, having an upper limit of 0.7 wt %, in another embodiment, having an upper limit of 0.5 wt %, in another embodiment, having an upper limit of 0.3 wt %, in another embodiment, having an upper limit of 0.2 wt %, in another embodiment, having an upper limit of 0.1 wt %, having an upper limit of 0.2 wt %, in another embodiment, having an upper limit of 0.05 wt %, having an upper limit of 0.2 wt %, in another embodiment, having an upper limit of 0.01 wt %, in another embodiment.

In another embodiment, the process water is further comprised of (optionally) one or more components utilized in the process to manufacture polysaccharides or derivatized polysaccharides (e.g., guar or derivatized guar) the following dissolved or dispersed (as fines) in the water, as follows: (iii) crosslinking agents (e.g., glyoxal or borax), (iv) diols or polyols (e.g., propylene glycol) (v) alkaline agents (e.g., NaOH), (vi) acids or salts thereof (e.g, salts of glycolic acid such as sodium glycolate), (vii) surfactants or (viii) combinations thereof. The one or more additional components can be present in an amount having an upper limited of (by weight of process water) 1 wt %, in one embodiment, having an upper limit of 0.7 wt %, in another embodiment, having an upper limit of 0.5 wt %, in another embodiment, having an upper limit of 0.3 wt %, in another embodiment, having an upper limit of 0.2 wt %, in another embodiment, having an upper limit of 0.1 wt %, having an upper limit of 0.2 wt %, in another embodiment, having an upper limit of 0.05 wt %, having an upper limit of 0.2 wt %, in another embodiment, having an upper limit of 0.01 wt %, in another embodiment.

In one embodiment, the process water is further comprised of one or more crosslinking agents (e.g., glyoxal or borax), which when utilized in the process to manufacture polysaccharides or derivatized polysaccharides (e.g., guar or derivatized guar) become dissolved or dispersed (as fines) in the water.

In one embodiment, the process water is further comprised of one or more diols or polyols (e.g., propylene glycol), which when utilized in the process to manufacture polysaccharides or derivatized polysaccharides (e.g., guar or derivatized guar) become dissolved or dispersed (as fines) in the water.

In one embodiment, the process water is further comprised of one or more alkaline agents (e.g., NaOH), which when utilized in the process to manufacture polysaccharides or derivatized polysaccharides (e.g., guar or derivatized guar) become dissolved or dispersed (as fines) in the water.

In one embodiment, the process water is further comprised of one or more acids or salts thereof (e.g, salts of glycolic acid such as sodium glycolate), which when utilized in the process to manufacture polysaccharides or derivatized polysaccharides (e.g., guar or derivatized guar) become dissolved or dispersed (as fines) in the water.

In one embodiment, the process water is further comprised of one or more cationic surfactants, which when utilized in the process to manufacture polysaccharides or derivatized polysaccharides (e.g., guar or derivatized guar) become dissolved or dispersed (as fines) in the water. The cationic surfactant is, in one embodiment, selected from i) certain quaternary salts and ii) certain amines, iii) amine oxide, iv) and combinations thereof

### EXAMPLES

### Example 1

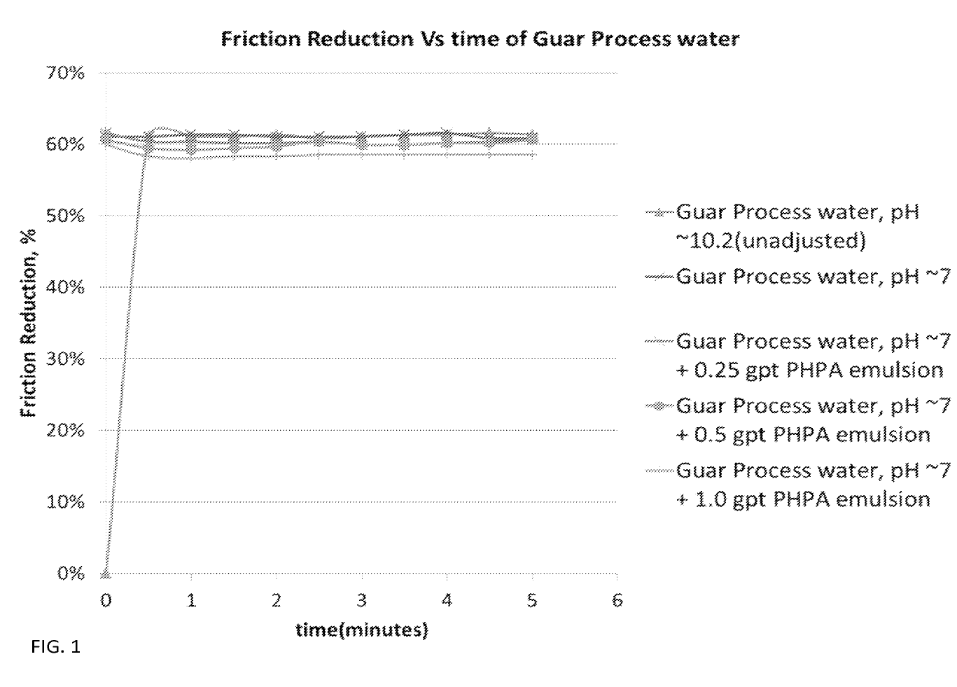

Referring to FIG. 1, the friction reducing properties of the guar process water; the process water exhibits a 60-65% friction reduction. It was observed that there was no or minimal effect due to pH, i.e., same behavior at pH 7 and pH 10. Friction reduction properties of the process water is similar as that seen with acrylamide based friction reducer fluid's (FR). It was observed that adding additional FR does not change, i.e., increase, the friction reduction properties of the process water.

### Example 2

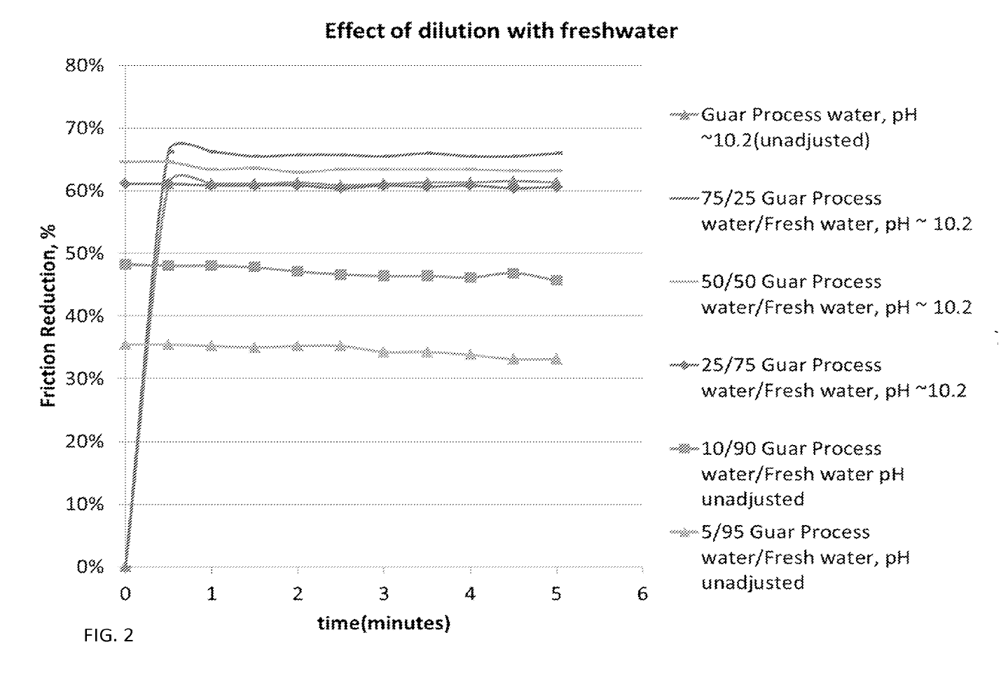

Referring to FIG. 2, friction reduction was observed at different dilution levels (with fresh water). It was observed that there is a slight increase in friction reduction when diluted with fresh water to 75/25 process water/fresh ratio. Further dilution results in decrease in friction reduction as shown in FIG. 2.

### Example 3

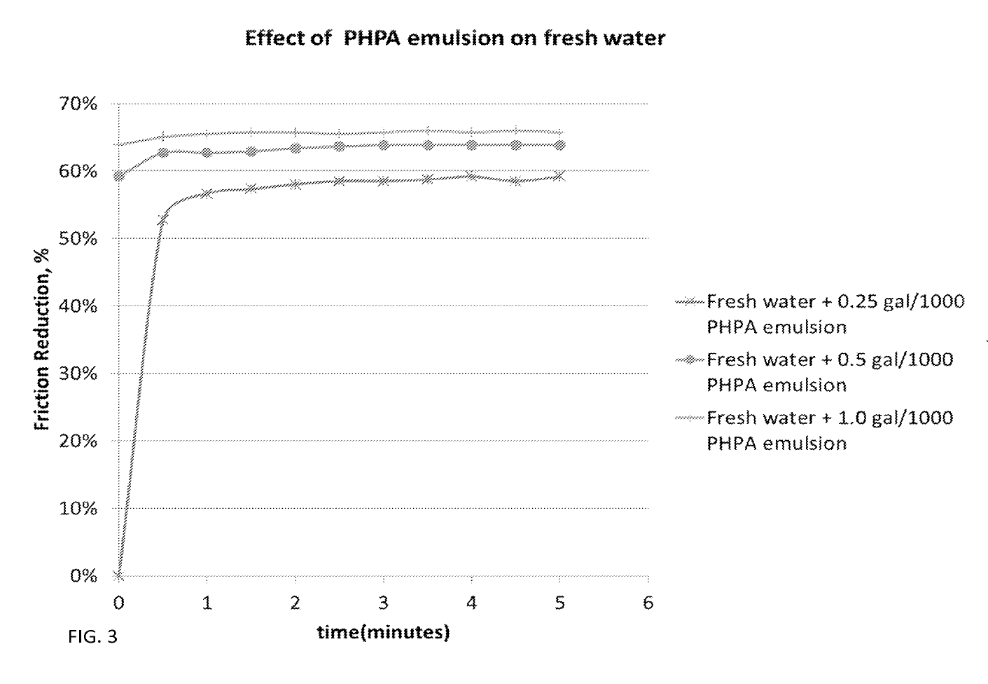

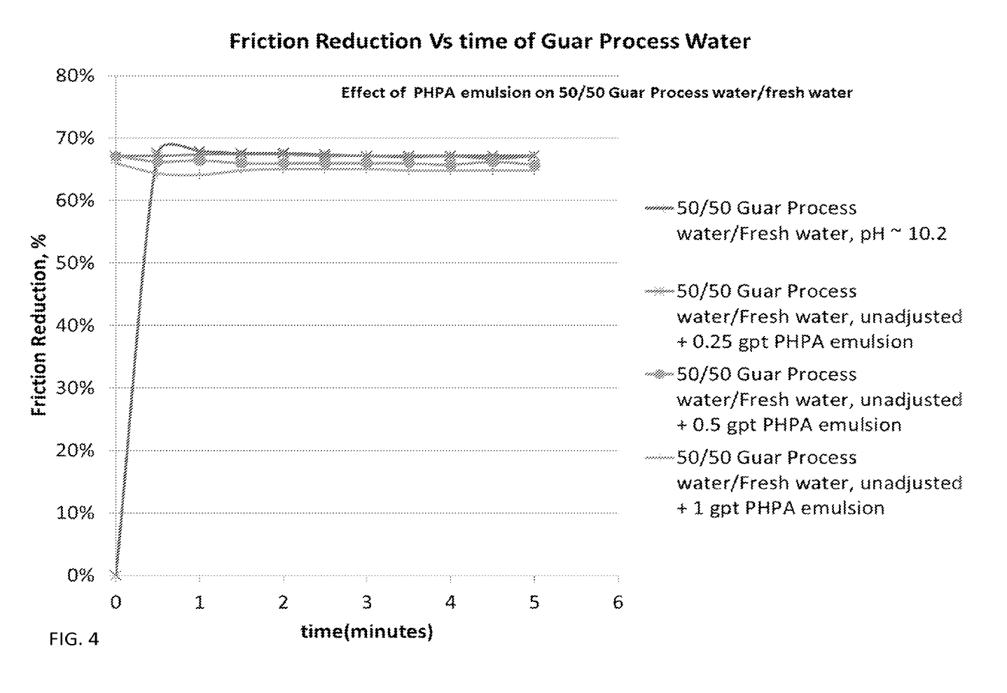

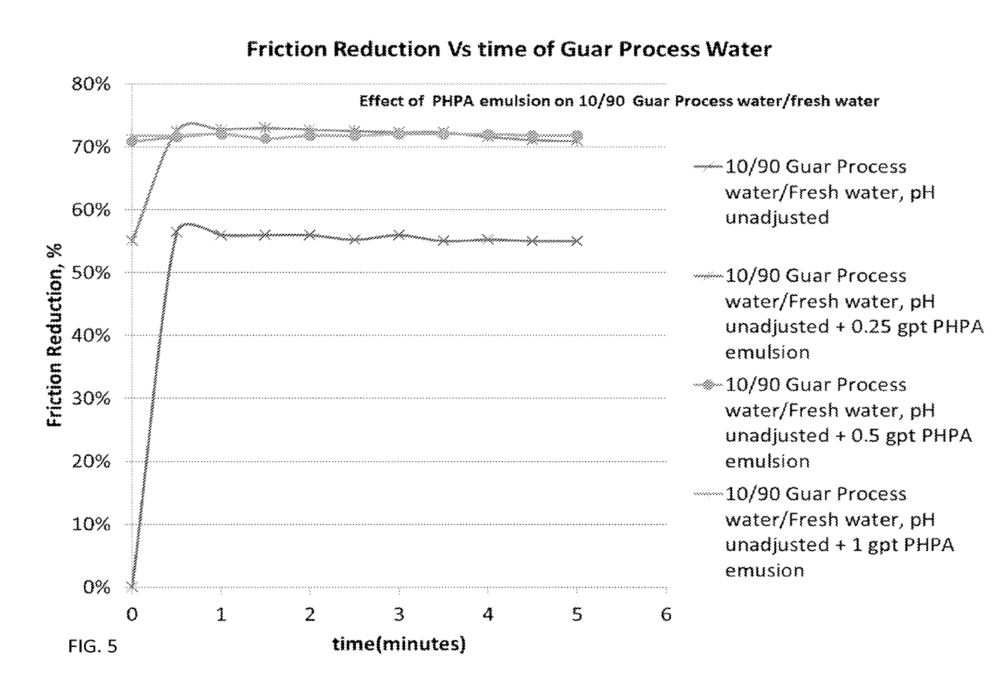

Referring to FIG. 3, shows a comparative example of a commercially available FR, “PHPA Emulsion” (anionic polyacrylamide), which exhibits about a 65% friction reduction. Referring to FIG. 4, adding PHPA Emulsion does not improve the friction reduction benefits in 50/50 guar process water/fresh water. Referring to FIG. 5, adding PHPA Emulsion improves the friction reduction benefits in 10/90 guar process water/fresh water ratio.

Process Water Compatible with Anionic FR

### Example 4

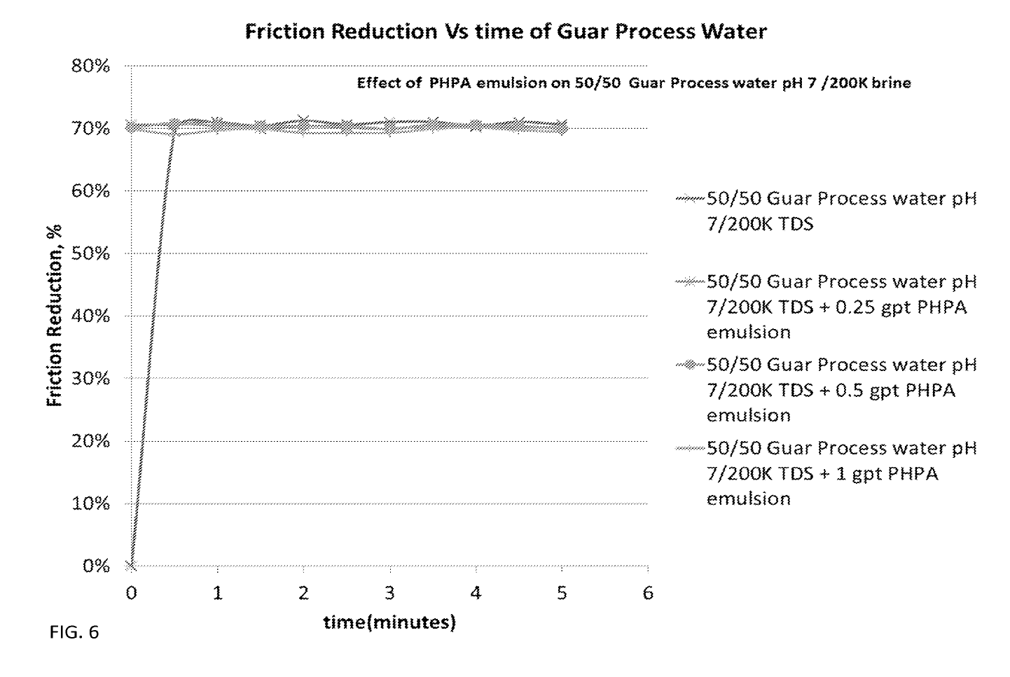

Referring to FIG. 6, shows the effect of PHPA Emulsion on 50/50 Mix of Guar Process Water/fresh water, respectively, with the addition of Total Dissolved Solids (TDS). The mixture works well even when mixed with high TDS brine. It is compatible with high TDS brines. Adding additional FR does not change the friction reduction

Guar Process Water exhibits good friction reduction that is comparable to typical anionic friction reducers. Works over a wide pH range and appears independent of pH. Guar Processing Side Stream from process water characterized by a pH of greater than pH 12, and optionally may need to be partially neutralized for hazard classification purposes. The Product pH may be modified to conform with desired characteristics such as product stability and customer requirement. It was generally observed that the guar processing side stream utilized as or as part of a friction reducer or in a slickwater application fluid is compatible with anionic friction reducer applications. No benefit was observed by adding anionic FR to process water. The Guar Process side stream appears to be compatible with high Total Dissolved Solids (TDS) brine.

It should be apparent that embodiments and equivalents other than those expressly discussed above come within the spirit and scope of the present invention. Thus, the present invention is not limited by the above description but is defined by the appended claims.

1. An oil field composition comprising a fracturing fluid composition prepared by a process comprising at least the steps of:
contacting a polysaccharide particle with water to produce process water, and
separating the process water from the polysaccharide particle, whereby the separated process water comprises at least part of the fracturing fluid composition.

2. The oil field composition of claim 1 further comprising one or more biocides, one or more surfactants, one or more scale inhibitors, one or more stabilizers or any of the foregoing.

3. The oil field composition of claim 1 wherein the process further comprising the step of treating the polysaccharide particle with an effective amount of a crosslinker to produce a polysaccharide particle.

4. (canceled)

5. (canceled)

6. (canceled)

7. The oil field composition of claim 1 wherein the step of contacting the polysaccharide particle with water to produce process water comprises: washing the polysaccharide particle in water.

8. (canceled)

9. The oil field composition of claim 1 wherein the polysaccharide particle is characterized by a substituent degree of substitution with a lower limit of 0.001 and an upper limit of 3, and a weight average molecular weight with a lower limit of 50,000 and an upper limit of 5,000,000.

10. (canceled)

11. The oil field composition of claim 1 wherein the polysaccharide particle is selected from the group comprising: guar, carboxymethyl guar (CMG), hydroxyethyl guar (HEG), hydroxypropyl guar (HPG), carboxymethylhydroxypropyl guar (CMHPG), cationic guar, cationic carboxymethyl guar (CMG), cationic hydroxyethyl guar (HEG), cationic hydroxypropyl guar (HPG), hydrophobically modified guar (HM guar), hydrophobically modified carboxymethyl guar (HMCM guar), hydrophobically modified hydroxyethyl guar (HMHE guar), hydrophobically modified hydroxypropyl guar (HMHP guar), cationic hydrophobically modified hydroxypropyl guar (cationic HMHP guar), hydrophobically modified carboxymethylhydroxypropyl guar (HMCMHP guar), hydrophobically modified cationic guar (HM cationic guar) or any combination thereof

12. (canceled)

13. The oil field composition of claim 1 wherein the process water is characterized by a pH in the range of between pH 3 and 13.

14. The oil field composition of claim 1 further comprising one or more surfactants, one or more scale inhibitors, one or more preservatives, one or more activators, one or more stabilizers or any of the foregoing.

15. (canceled)

16. A method of treating a subterranean formation, comprising:
providing the oil field composition of claim 1; and
introducing the oil field composition into a wellbore penetrating the subterranean formation.

17. (canceled)

18. The method of claim 16 further comprising providing one or more synthetic polymers, one or more second polysaccharides, one or more viscosity modifiers, one or more gelling agents or any combination thereof

19. The method of claim 16 further comprising a cross-linking agent, wherein at least a portion of the oil field composition forms a gel.

20. The method of claim 16 wherein the step of contacting the polysaccharide particle with water comprises: washing the polysaccharide particle in water, wherein the polysaccharide particle has a substituent degree of substitution with a lower limit of 0.001 and an upper limit of 3.0, and a weight average molecular weight with a lower limit of 50,000 and an upper limit of 5,000,000.

21. (canceled)

22. (canceled)

23. The method of claim 16 wherein the polysaccharide particle is selected from the group comprising: guar, carboxymethyl guar (CMG), hydroxyethyl guar (HEG), hydroxypropyl guar (HPG), carboxymethylhydroxypropyl guar (CMHPG), cationic guar, cationic carboxymethyl guar (CMG), cationic hydroxyethyl guar (HEG), cationic hydroxypropyl guar (HPG), hydrophobically modified guar (HM guar), hydrophobically modified carboxymethyl guar (HMCM guar), hydrophobically modified hydroxyethyl guar (HMHE guar), hydrophobically modified hydroxypropyl guar (HMHP guar), cationic hydrophobically modified hydroxypropyl guar (cationic HMHP guar), hydrophobically modified carboxymethylhydroxypropyl guar (HMCMHP guar), hydrophobically modified cationic guar (HM cationic guar) or any combination thereof

24. The method of claim 16 wherein the water is characterized by a pH in the range of between pH 8 and 13.

25. The method of claim 16 wherein the step of introducing the oil field composition into the wellbore penetrating the subterranean formation comprises introducing the oil field composition at a pressure sufficient to create, expand or sustain a fracture in the subterranean formation.

26. (canceled)

27. A method of treating a subterranean formation, comprising:
introducing an oil field composition into a wellbore penetrating the subterranean formation,
whereby the oil field composition comprises process water obtained in the process of manufacturing polysaccharide or derivatized polysaccharide.

28. The method of claim 27 wherein the polysaccharide is guar.

29. The method of claim 27 wherein the step of introducing the oil field composition into the wellbore penetrating the subterranean formation comprises introducing the oil field composition at a pressure sufficient to create, expand or sustain a fracture in the subterranean formation.

30. (canceled)

31. (canceled)

32. (canceled)

33. A method of producing an application fluid composition comprising at least the steps of:
contacting a polysaccharide particle with water to produce process water, and
separating the process water from the polysaccharide particle, whereby the separated process water comprises at least part of the application fluid composition.

34. (canceled)

35. (canceled)

36. (canceled)

37. (canceled)

38. (canceled)

39. (canceled)

40. The method of claim 33 wherein the polysaccharide particle is selected from the group comprising: guar, carboxymethyl guar (CMG), hydroxyethyl guar (HEG), hydroxypropyl guar (HPG), carboxymethylhydroxypropyl guar (CMHPG), cationic guar, cationic carboxymethyl guar (CMG), cationic hydroxyethyl guar (HEG), cationic hydroxypropyl guar (HPG), hydrophobically modified guar (HM guar), hydrophobically modified carboxymethyl guar (HMCM guar), hydrophobically modified hydroxyethyl guar (HMHE guar), hydrophobically modified hydroxypropyl guar (HMHP guar), cationic hydrophobically modified hydroxypropyl guar (cationic HMHP guar), hydrophobically modified carboxymethylhydroxypropyl guar (HMCMHP guar), hydrophobically modified cationic guar (HM cationic guar) or any combination thereof.

41. (canceled)
